(19) United States
(12) Patent Application Publication
(10) Pub. No.: US 2021/0257780 A1
(43) Pub. Date: Aug. 19, 2021

(54) ELECTRIC PLUG

(71) Applicant: DONG SAN ELECTRONICS CO., LTD., Gimhae-si, Gyeongsangnam-do (KR)

(72) Inventor: Dae Ho LEE, Gimhae-si, Gyeongsangnam-do (KR)

(21) Appl. No.: 16/094,517

(22) PCT Filed: Aug. 17, 2018
(86) PCT No.: PCT/KR2018/009453

§ 371 Date: Oct. 18, 2018

(30) Foreign Application Priority Data
Aug. 17, 2017 (KR) 10-2017-0104183

(51) Int. Cl. H01R 13/629; H01R 13/633; H01R 24/28

(52) U.S. Cl. CPC H01R 13/62944; H01R 2103/00; H01R 24/28; H01R 13/6335

(57) ABSTRACT

The present invention discloses a plug. A plug body 10 includes a pair of contact pins P for electrical contact and a lever-receiving groove 12. A single manipulation lever 20, is rotationally supported by a support shaft 22 within the lever-receiving groove 12, and includes a manipulation arm 24, and a gear arm 26 having a gear part 26a. A up and down movement member 40 includes a rack gear part 42, and a push pin 44 for entering or exit from the bottom of the plug body. When the up and down movement member moves down by a rotational movement of the manipulation lever 20, the push pin protrudes from the bottom of the plug body and presses a top of the socket, so the plug is separated from the socket.

### CROSS REFERENCE TO RELATED APPLICATION

This present application is a national stage filing under 35 U.S.C § 371 of PCT application number PCT/KR2018/009453 filed on Aug. 17, 2018 which is based upon and claims the benefit of priority to Korean Patent Application No. 10-2017-0104183 filed on Aug. 17, 2017 in the Korean Intellectual Property Office. The disclosures of the above-listed applications are hereby incorporated by reference herein in their entirety.

### TECHNICAL FIELD

The present invention relates to an electric plug, and more particularly, to an electric plug configured to be easily drawn out from a socket and to have a maximum movement distance in the separation direction of the electric plug through one manipulation lever.

### BACKGROUND

There have been proposed plugs of various forms for being easily separated from sockets. For example, there is Korean Patent Application Publication No. 10-2017-0014685 filed by this applicant. In the prior art, inconvenience in use and damage attributable to an external force may occur because a manipulation lever manipulated by a user in order to separate a plug from a socket is positioned on the outside of a plug body.

Furthermore, the shape and design of a part manipulated by a user in order to draw the plug from the socket substantially have close connections with the shape and design of the plug body. For example, the relative movement distance of the plug substantially changes with respect to the socket according to the coupling relation with the shape of the manipulation lever manipulated by a user and surrounding elements. That is, in order for the plug to be certainly separated from the socket, a total movement distance of the plug must be sufficiently secured by manipulating the manipulation lever. The conventional technology may be said to have a specific limit in securing a total movement distance of the plug.

Accordingly, the present invention has been made in view of the above problems, and it is a major object of the present invention to easily separate a plug from a socket by securing a maximum movement distance of the plug through the manipulation of a manipulation lever in the plug which can be moved in a specific distance in the separation direction of the plug using the manipulation lever positioned in the plug without separating the plug from the socket by applying a user's force in the separation direction of the plug.

Furthermore, another object of the present invention is to provide a plug capable of achieving a reduction of the number of parts and improving productivity by simplifying the number of parts forming the plug and thus simplifying an assembly task.

### Advantageous Effect

The plug of the present invention includes a plug body including a pair of contact pins inserted into a socket to form an electrical contact and a lever-receiving groove concavely formed from one side of the plug body to an inside; a manipulation lever rotationally supported by a support shaft within the lever-receiving groove and including a manipulation arm formed on the outside of the support shaft and a gear arm having a gear part at the end of the manipulation lever; and an up and down movement member including a rack gear part engaged with the gear part and a push pin downward extended from the rack gear part to enter or exit from the bottom of the plug body and supported to move up and down in a specific section within the plug body, wherein when the up and down movement member moves down through association between the gear art and the rack gear part by a rotational movement of the manipulation lever, the push pin protrudes from the bottom of the plug body and presses the top of the socket.

Furthermore, according to an embodiment of the present invention, the rack gear part is positioned in a center line in the up and down direction of the plug body or positioned on the side opposite the manipulation lever in the center line. Accordingly, the distance from the support shaft to the rack gear part of the up and down movement member or the gear part of the manipulation lever is increased. Accordingly, the downward movement distance of the up and down movement member according to a rotational movement of the manipulation lever is increased.

According to another embodiment of the present invention, the lever-receiving groove includes a side open part formed by opening at least part of the side of the plug body.

Or the lever-receiving groove of the present invention may include a side open part formed by opening at least part of the side of the plug body and the top open part connected to the side open part and formed by opening at least part of the top of the plug body.

### BRIEF SUMMARY

The plug of the present invention includes a plug body including a pair of contact pins inserted into a socket to form an electrical contact and a lever-receiving groove concavely formed from one side of the plug body to an inside; a manipulation lever rotationally supported by a support shaft within the lever-receiving groove and including a manipulation arm formed on the outside of the support shaft and a gear arm having a gear part at the end of the manipulation lever; and an up and down movement member including a rack gear part engaged with the gear part and a push pin downward extended from the rack gear part to enter or exit from the bottom of the plug body and supported to move up and down in a specific section within the plug body, wherein when the up and down movement member moves down through association between the gear art and the rack gear part by a rotational movement of the manipulation lever, the push pin protrudes from the bottom of the plug body and presses the top of the socket.

Furthermore, according to an embodiment of the present invention, the rack gear part is positioned in a center line in the up and down direction of the plug body or positioned on the side opposite the manipulation lever in the center line. Accordingly, the distance from the support shaft to the rack gear part of the up and down movement member or the gear part of the manipulation lever is increased. Accordingly, the downward movement distance of the up and down movement member according to a rotational movement of the manipulation lever is increased.

According to another embodiment of the present invention, the lever-receiving groove includes a side open part formed by opening at least part of the side of the plug body.

Or the lever-receiving groove of the present invention may include a side open part formed by opening at least part of the side of the plug body and the top open part connected to the side open part and formed by opening at least part of the top of the plug body.

### BRIEF DESCRIPTION OF DRAWINGS

FIG. 1 is a perspective view showing an example of an electric plug of the present invention.

FIG. 2 is a perspective view showing a partially cut portion of the electric plug of the present invention.

FIG. 3 is a vertical cross-sectional view of the electric plug of the present invention.

FIG. 4 is an explanatory diagram illustrating an operation of a manipulation lever and an up and down movement member.

### DETAILED DESCRIPTION OF THE PREFERRED EMBODIMENTS

Hereinafter, the present invention is described more specifically based on embodiments shown in the drawings.

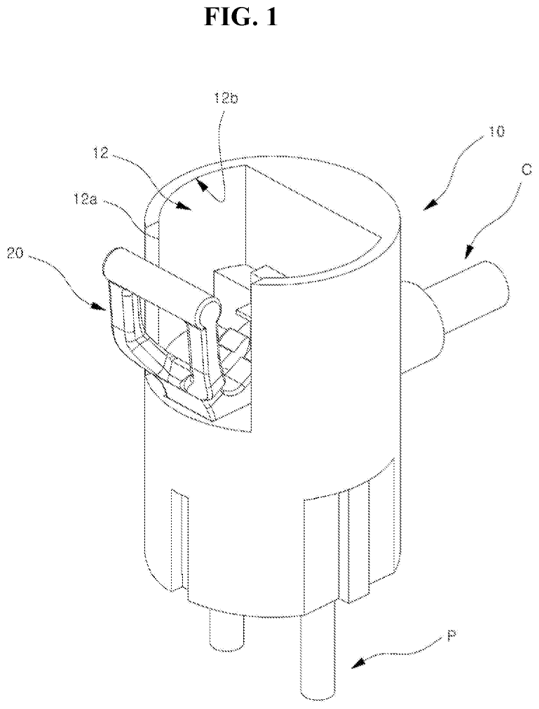

As shown in FIGS. 1 to 3, a plug of the present invention includes a pair of contact pins P inserted into a socket for an electrical contact and a plug body 10 made of synthetic resins (insulating material) to support the contact pins P. And an electric line C for supplying electricity to home appliances is positioned on one side of the plug body 10. According to the present invention, a lever-receiving groove 12 is formed on one side of the plug body 10.

The lever-receiving groove 12 of the present invention is formed to receive a manipulation lever 20 therein and to permit a rotational movement of the manipulation lever 20 therein. And the lever-receiving groove 12 is formed to open part of the side and part of the top of the plug body 10 in a continuous form. That means that the side open part 12a and top open part 12b of the lever-receiving groove 12 are formed to communicate with each other. The continuous open parts 12a and 12b substantially have a close relation with a rotation angle of the manipulation lever 20.

And the upper part of the plug body 10 forms a top surface 12e, excluding the top open part 12b. The top surface 12e may be used a portion that applies a force when the plug body 10 is put into the socket.

A rotation angle of the manipulation lever 20 increases as an angle from the side open part 12a of the lever-receiving groove 12 to the top open part 12b increases. And increasing the rotation angle of the manipulation lever 20 means that the descent distance of an elevation member 40 is sufficiently increased as may be seen from the following description.

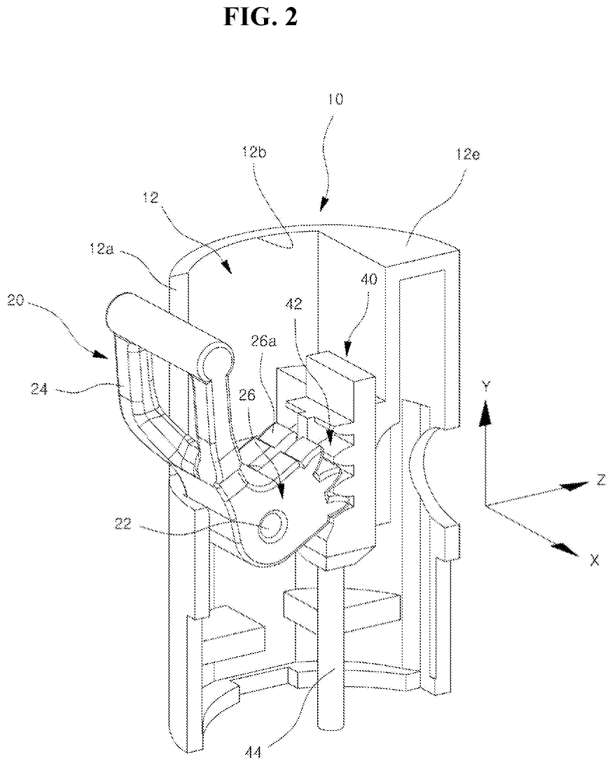

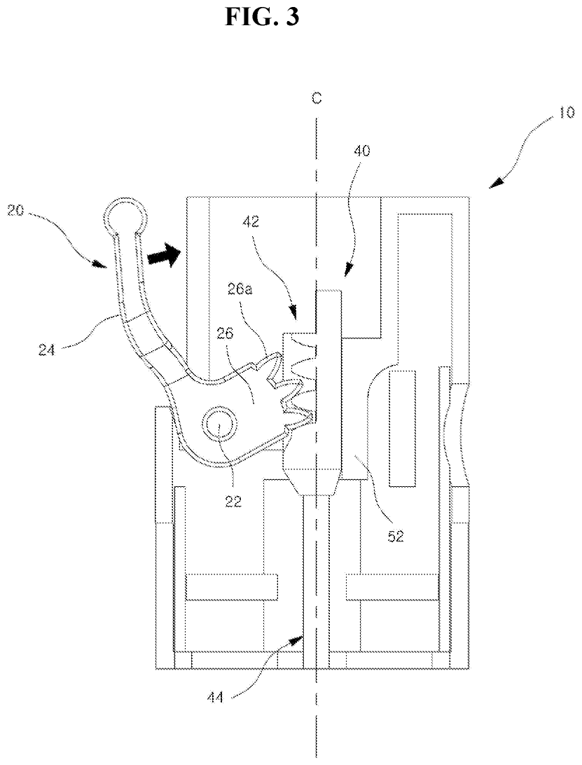

In this case, the up and down movement distance of the elevation member 40 is described in brief with reference to FIGS. 2 and 3. When the up and down movement distance of the elevation member 40 increases, the length that the elevation member 40 protruding from the bottom of the plug body 10 is substantially long. Accordingly, if the up and down movement distance of the elevation member 40 is long, the plug can be separated more easily from the socket, since plug can rise by the elevation member's contact to the socket.

However, there is a limit in increasing the rotation angle of the manipulation lever 20 in the plug body 10 having a predetermined size. The present invention is based on the ideas that the up and down movement of the elevation member 40 is maximized in the range in which the rotational movement range of the manipulation lever 20 has been predetermined because to increase the rotation angle of the manipulation lever is limited.

In the present invention, a manipulation lever 20 is rotationally supported by a support shaft 22 within the lever-receiving groove 12. The manipulation lever 20 of the present invention includes a manipulation arm 24 exposed to the outside of the plug body 10 in the outside part of the support shaft 22 and manipulated by a user and a gear arm 26 extending to the support shaft 22.

The manipulation arm 24 and the gear arm 26 are formed at a specific angle. When the manipulation arm 24 rotationally moves inside, that is into the lever-receiving groove 12 on the support shaft 22, the gear arm 26 is formed to have a specific angle in such a way as to downward move around the support shaft 22. A gear part 26a is formed at the end of the gear arm 26. In the manipulation lever 20 of the present invention having such a configuration, the gear arm 26 is supported by the plug body 10 in a downward direction when the manipulation arm 24 is pushed inwardly.

And the manipulation lever 20 of the present invention functions to push the elevation member 40 downward as described above. The elevation member 40 of the present invention includes a rack gear part 42 engaged with the gear part 26a of the gear arm 26 and a push pin 44 downward extended from the rack gear part 42 to enter or exit from the bottom of the plug body 10. Accordingly, when the manipulation lever 20 rotates, the gear part 26a makes the elevation member 40 go down through the rack gear part 42, so the push pin 44 is protruded toward the bottom of the plug body 10.

In the present invention, the elevation member 40 is supported in such a way as to move up and down only within the plug body 10. For example, a guide member 52 shown in FIG. 3 is supported so that the elevation member does not move in a Z direction (refer to FIG. 2). That is, referring to FIG. 2, the elevation member 40 is supported to not move in the X-axis and Z-axis directions, but is supported by the guide member (not shown) to move up and down only in the Y-axis direction. For example, the elevation member 40 is supported within a rail groove formed up and down within the plug body 10 and configured to move up and down by only interlocking with the manipulation lever 20.

The elevation operation of the elevation member 40 according to the rotational movement of the manipulation lever 20 is described with reference FIG. 3. In this case, the state of FIG. 3 shows the state in which the plug body 10 has been substantially put into a socket (not shown), that is, the state in which electricity is supplied. And the following description of an operation follows a process of separating the plug from the socket in the state in which the plug has been put into the socket.

As in FIG. 3, in order to separate the plug body 10 from the socket, the manipulation lever 20 needs to be clockwise (refer to an arrow) manipulated around the support shaft 22. When the manipulation arm 24 is pushed inwardly and thus the manipulation lever 20 is turned as described above, the gear part 26a of the gear arm 26 of the manipulation lever 20 is turned clockwise.

Accordingly, the rack gear part 42 moves downward. The downward movement of the rack gear part 42 makes the elevation member 40 go downward, so the push pin 44 is protruded to the bottom of the plug body 10. At this time, the bottom of the push pin 44 pushes the top of the socket. The plug body 10 moves upward with respect to the socket that has been relatively fixed. When the plug body 10 moves upward in the socket of the fixed state, the contact pins P of the plug is substantially separated from the socket.

In this case, in order for the plug body 10 to be certainly separated from the socket, the quantity that the push pin 44 forming the bottom of the elevation member 40 is protruded from the bottom of the plug body 10 must be great. That is, the plug may be certainly separated from the socket only when the up and down movement distance of the elevation member 40 is increased.

In the aforementioned conventional technology, to increase the up and down movement distance (stroke distance) of the elevation member is inevitably limited because a pair of left and right manipulation levers is configured. In the present invention, however, not a pair of manipulation levers 20, but a single manipulation lever 20 is configured, and the manipulation lever 20 is basically configured to maximize the up and down stroke distance of the elevation member 40 according to the operation of the gear part 26a.

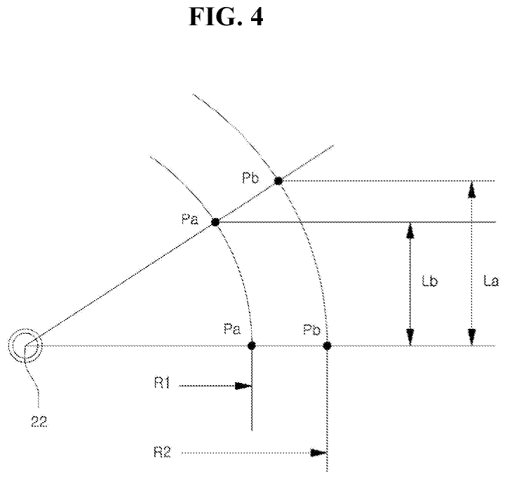

One of schemes for increasing the elevation distance of the elevation member 40 may include increasing the length from the support shaft 22 to the gear part 26a. That is, as shown in FIG. 4, if the gear part 26a is formed in the distance R2 from the support shaft 22 longer than R1, a moving trajectory having a line to connect Pb-Pb by rotation is formed. The up and down movement member 40 has an up and down movement distance La when the gear part 26a rotationally moves at a specific angle.

Furthermore, when the gear part 26a is formed in the distance R1 from the support shaft 22, a moving trajectory having a line to connect Pa-Pa by rotation is formed. Accordingly, the up and down movement member 40 has an up and down movement distance Lb when the gear part 26a is turned at a specific angle. It may be seen that the up and down stroke length of the up and down movement member 40 is long as the distance between the gear parts 26a is longer from the support shaft 22.

Accordingly, in the present invention, in order to lengthen the distance from the support shaft 22 to the rack gear part 42, an up and down movement member is positioned so that the rack gear part 42 is engaged with a center line C in the up and down direction of the plug body 10 or positioned on the side opposite the center line C (right side in the drawing). That is, when the single manipulation lever 20 is configured and positioned on one side of the plug body 10, the rack gear part 42 of the up and down movement member 40 is designed to be formed in the center line of the plug body 10 or to be positioned on the side opposite the center line of the plug body 10.

Furthermore, to design the up and down movement member 40 so that the rack gear part 42 is engaged with the center line C of the plug body 10 or positioned on the side opposite the center line C of the manipulation lever 20 may be based on the premise that the single manipulation lever 20 is configured and will move downward in association with the up and down movement member 40. That is, this may be said to be a technical idea for overcoming the limit of the up and down movement distance when a pair of manipulation levers is configured.

Accordingly, when a manipulator fully pushes the manipulation arm 24 of the manipulation lever 20 inside, the up and down movement member 40 substantially reaches a bottom dead point. At the same time, the push pin 44 may push the top of the socket, so the contact pins P will be separated from the socket. Through such an operation, the plug can be easily separated from the socket by pressing the manipulation lever 20 positioned on one side of the plug body without an effort to draw the plug from the substantially fixed socket by directly holding the plug.

Furthermore, an operation of putting the plug body 10 into the socket back is substantially the same as an operation of putting the socket. That is, the plug body 10 is coupled to the socket in the state in which the contact pins P have been matched with the corresponding holes of the socket by holding the plug body 10 by pushing the plug body 10. In this process, the contact pins P protruded to the bottom of the plug body 10 enter the plug body 20 again, and the manipulation lever 20 also operates in conjunction with the operation of the up and down movement member 40. Furthermore, when the plug body 10 is fully put into the socket, the plug body 10 will maintain the state, such as that shown in FIG. 3.

A modification or design change of each element of the present invention having such a configuration is described below.

In the illustrated embodiment, the lever-receiving groove 12 into which the manipulation lever 20 has been inserted includes the side open part 12a and the top open part 12b. However, the lever-receiving groove 12 of the present invention is sufficient if the manipulation lever 20 substantially inserted into the lever-receiving groove 12 has only to be manipulated. The lever-receiving groove 12 includes an open part on at least on one side, and the manipulation lever 20 has only to be manipulated through the open part. For example, although only part on the side is open, the manipulation lever 20 can be sufficiently practiced if the manipulation lever within the lever-receiving groove 12 can be manipulated. Furthermore, although only part of the top is open, the manipulation lever 20 can be sufficiently practiced if the manipulation lever within the lever-receiving groove 12 can be manipulated. Furthermore, the shape and installation position of the manipulation lever 20 may be changed in various manners if the manipulation lever 20 of the present invention can substantially rotationally moves and the up and down movement member can move downward through a coupled part.

Various other modifications are possible to those skilled in the art within a basic technical category of the present invention, and it is evident that the scope of protection of the present invention should be determined based on contents described in the claims in terms of the regulations of the patent law.

1. A plug, comprising:
a plug body comprising a pair of contact pins inserted into a socket to form an electrical contact and a lever-receiving groove concavely formed from one side of the plug body to an inside;
a manipulation lever rotationally supported by a support shaft within the lever-receiving groove and comprising a manipulation arm formed on the outside of the support shaft and a gear arm having a gear part at an end of the manipulation lever; and
an up and down movement member comprising a rack gear part engaged with the gear part and a push pin downward extended from the rack gear part to enter or exit from a bottom of the plug body and supported to move up and down in a specific section within the plug body, wherein when the up and down movement member moves down through association between the gear art and the rack gear part by a rotational movement of the manipulation lever, the push pin protrudes from the bottom of the plug body and presses a top of the socket.

2. The plug of claim 1, wherein the rack gear part is positioned in a center line in the up and down direction of the plug body or positioned on a side opposite the manipulation lever in the center line.

3. The plug of claim 2, wherein the lever-receiving groove comprises a side open part formed by opening at least part of the side of the plug body.

4. The plug of claim 2, wherein the lever-receiving groove comprises:
a side open part formed by opening at least part of the side of the plug body, and
a top open part connected to the side open part and formed by opening at least part of a top of the plug body.
